(19) United States
(12) Patent Application Publication
(10) Pub. No.: US 2015/0006230 A1
(43) Pub. Date: Jan. 1, 2015

(54) ARTICLE PROCESSING APPARATUS, GENERATING METHOD, AND COMPUTER-READABLE STORAGE MEDIUM

(71) Applicant: CANON KABUSHIKI KAISHA, Tokyo (JP)

(72) Inventors: Hiroyuki Yuki, Utsunomiya-shi (JP); Yutaka Niwayama, Kawasaki-shi (JP)

(21) Appl. No.: 14/317,533

(22) Filed: Jun. 27, 2014

(30) Foreign Application Priority Data
Jun. 28, 2013 (JP) 2013-136920

(51) Int. Cl. G06Q 10/04; G06Q 50/04; G06Q 10/06

(52) U.S. Cl. CPC G06Q 10/047; G06Q 10/06315; G06Q 50/04
USPC 705/7.25

(57) ABSTRACT

An article processing apparatus, having a movable member for article processing, includes an information processor configured to set a plurality of clusters each of which includes, as a plurality of nodes, a plurality of candidates of a transition order of states of the movable member with respect to each of a plurality of target regions of an article, set a plurality of costs respectively to a plurality of combinations of two nodes which respectively belong to two mutually different clusters of the plurality of clusters, and generate a transition order of states of the movable member over the plurality of target regions by obtaining, as a solution of a traveling salesman problem, an order of traveling through a plurality of nodes each selected from each of the plurality of clusters, based on the plurality of clusters and the plurality of costs.

### BACKGROUND OF THE INVENTION

1. Field of the Invention

The present invention relates to an article processing apparatus having a movable member for article processing, a generating method of generating a transition order of states of the movable member, and a computer-readable storage medium.

2. Description of the Related Art

It is an important problem to shorten time required for measurement or processing in using a measuring device or a processing device. The measuring device herein represents, for example, a device which moves a movable member (measurement head) and measures several parts of an article to be measured such as a workpiece. The processing device herein represents, for example, a device which moves a movable member (processing head) and processes several parts of an article to be processed such as of a workpiece. In order to solve the above-mentioned problem, technology of selecting a moving route of a movable member to shorten total traveling time as well as measurement time or processing time has been known in the related art (Japanese Patent Application Laid-open No. 07-210586 and WO2003/064107). Japanese Patent Application Laid-open No. 07-210586 and WO2003/064107 have devised to solve traveling salesman problems (TSPs). Herein, places for carrying out measurement or processing are described as nodes, and time required for traveling between each of the nodes is described as a cost. By such solutions for the TSPs, Japanese Patent Application Laid-open No. 07-210586 and WO2003/064107 have attempted to shorten the time required for measurement or processing.

The technology recited in Japanese Patent Application Laid-open No. 07-210586 optimizes the route of the movable member (probe) and utilizes the solution for the TSP as described above. However, as the number of the nodes increases, calculation time for solving the TSP exponentially increases. Therefore, it is difficult to make the technology practicable.

By contrast, in WO2003/064107, a region including “processing positions (nodes)” is divided in advance into several “processed rectangles (several regions)”. Herein, a visiting order of the nodes, which yields a minimum cost within each region, is determined and a moving route between the regions is subsequently determined. In this manner, WO2003/064107 has attempted to decrease the number of the nodes in each TSP and to shorten total calculation time. However, this method determines the moving route between the regions only after determining the visiting order within each region. In other words, in determining the visiting order within the region, the moving route between the regions is not taken into consideration. Further, the moving route between the regions is determined based on predetermined information of an entrance and an exit of each region. Accordingly, a solution which can be eventually obtained is not an overall optimal solution for traveling through all the nodes at a minimum or quasi-minimum cost, but a partial optimal solution. As mentioned above, the method recited in WO2003/064107 is not the overall optimal solution in which both the visiting order within the region and the moving route between the regions are taken into consideration. As a result, a route which further shortens processing time may possibly exist.

Accordingly, it has been difficult, in the related art, to obtain the overall optimal solution within a practical time. Moreover, the related art has been insufficient for creating a state transition order of the movable member, which is advantageous in terms of time required for article processing such as measurement and processing.

### SUMMARY OF THE INVENTION

The present invention provides, for example, technique of generating a transition order of states of a movable member, which is advantageous in terms of time for article processing.

An aspect of the present invention is an article processing apparatus having a movable member for article processing, the apparatus including an information processor configured to set a plurality of clusters each of which includes, as a plurality of nodes, a plurality of candidates of a transition order of states of the movable member with respect to each of a plurality of target regions of an article, set a plurality of costs respectively to a plurality of combinations of two nodes which respectively belong to two mutually different clusters of the plurality of clusters, and generate a transition order of states of the movable member over the plurality of target regions by obtaining, as a solution of a traveling salesman problem, an order of traveling through a plurality of nodes each selected from each of the plurality of clusters, based on the plurality of clusters and the plurality of costs.

Further features of the present invention will become apparent from the following description of exemplary embodiments (with reference to the attached drawings).

### BRIEF DESCRIPTION OF THE DRAWINGS

FIG. 1 is a chart (flowchart) showing a procedure of information processing for creating a state transition order of a movable member.

FIG. 2 is a view showing an exemplary configuration of an article processing apparatus.

FIG. 3 is a view for explaining details of information processing.

FIGS. 4A to 4H are diagrams for explaining details of information processing.

FIGS. 5A and 5B are diagrams for explaining details of information processing.

FIGS. 6A to 6C are diagrams for explaining details of information processing.

FIGS. 7A and 7B are diagrams for explaining details of information processing.

FIGS. 8A to 8G are diagrams for explaining details of information processing.

FIGS. 9A to 9C are diagrams for explaining details of information processing.

FIG. 10 is a view showing a specific example of a measuring device.

### DESCRIPTION OF THE EMBODIMENTS

Hereinafter, embodiments of the present invention will be described with reference to the attached drawings. Through all the drawings for explaining the embodiments, the same members and the like will be denoted with the same signs and duplicative explanation thereof will be omitted as a general rule (unless otherwise noted).

First, a narrowly-defined (or non-generalized) traveling salesman problem (TSP) will be described. Next, a generalized traveling salesman problem (GTSP) will be described. Hereinafter, those problems will be collectively called a “traveling salesman problem”. The TSP is a problem in a graph in which several nodes, edges connecting each node, and costs required for travelling between those nodes (edges) are defined. The TSP is a problem for obtaining, in the graph, a route in which a sum of the costs is minimized. The costs herein are those required for passing through all the nodes once and making a circuit of (traveling through) all the nodes. A solution for this problem has been utilized industrially. For example, as described above, Japanese Patent Application Laid-open No. 07-210586 and WO2003/064107 have attempted to solve the TSPs. Herein, places for measurement and processing are described as nodes, and time required for traveling between the nodes is described as a cost. By such solutions for the TSPs, Japanese Patent Application Laid-open No. 07-210586 and WO2003/064107 have attempted to shorten the time required for measurement or processing.

Examples of the TSP herein include a symmetric traveling salesman problem (STSP) and an asymmetric traveling salesman problem (ATSP). The STSP is a problem in which costs between nodes have the same value regardless of a traveling direction between the nodes. On the other hand, the ATSP is a problem in which costs between nodes have different values depending on a traveling direction between the nodes. An ATSP is convertible into an STSP as described in Non-Patent Literature 1 (Operations Research Letters, Volume 2, Issue 4, November 1983, pp. 161-163). In fact, there are many cases where ATSPs are converted into STSPs and are solved by solutions for the STSP. The solutions for the STSP include a method of obtaining an exact solution and a method of obtaining a quasi-optimum solution. The exact solution guarantees that a sum of the costs is minimized. On the other hand, the quasi-optimum solution does not guarantee that the sum of the costs is minimized, but the sum in the quasi-optimum solution is sufficiently less than those of other solutions. Therefore, the quasi-optimum solution is considered useful from a practical point of view. A method for obtaining the exact solution has been disclosed in Non-Patent Literature 2 (Computational Combinatorial Optimization, pp. 261-303, 2001). A method for obtaining the quasi-optimum solution is known as a heuristic such as a Lin-Kernighan heuristic, a simulated annealing heuristic, and a genetic algorithm disclosed in Non-Patent Literature 3 (Tech. Rep. 99885 TR99-05, Dept. Comput. Appl. Math., Rice University).

Next, explanation for the GTSP will be described. The GTSP is a problem in a graph in which several clusters and several costs are defined. Each of the several clusters herein includes (a set of) several nodes. The several costs herein respectively correspond to several combinations of two nodes respectively belonging to two different clusters. The GTSP is a problem for solving, in such a graph, a route in which a sum of the costs is minimized. The costs herein are those required for making a circuit of the several nodes by passing through each node once, the nodes being respectively selected from the several clusters. That is, the TSP and the GTSP are different in that a route of the GTSP passes through one node per cluster, while a route of the TSP passes through all the nodes. In other words, the GTSP selects an order of visiting the several clusters and at the same time selects one node from the several nodes in each cluster in order to minimize the traveling cost.

Examples of the GTSP herein also include a symmetric GTSP (S-GTSP) and an asymmetric GTSP (A-GTSP). The S-GTSP is a GTSP in which costs between nodes have the same value regardless of a traveling direction between the nodes. On the other hand, the A-GTSP is a GTSP in which costs between nodes have different values depending on a traveling direction between the nodes. Solutions for such GTSPs have been disclosed in Non-Patent Literatures 4 to 6. Non-Patent Literature 4 (Proceedings of the 15th International Conference of Systems Engineering, ICSE (2002), pp. 43-46) discloses a method for converting a GTSP into an ATSP. An ATSP can be converted into an STSP as described above. Accordingly, a solution for the GTSP can be eventually obtained by solving the converted STSP. Herein, an exact solution for the STSP is guaranteed as a feasible solution for the original GTSP and as an exact solution for the original GTSP. However, a quasi-optimum solution for the above-mentioned STSP may not be guaranteed as a feasible solution for the original GTSP. That is, although the GTSP is a problem which requires a solution for vising each of the clusters once, the quasi-optimum solution for the above-mentioned STSP may include a solution for visiting one cluster several times. Therefore, Non-Patent Literature 5 (European Journal of Operational Research, Volume 208, Issue 3, 1 Feb. 2011, pp. 221-232) and Non-Patent Literature 6 (European Journal of Operational Research, Volume 219, Issue 2, 1 Jun. 2012, pp. 234-251) each extend the Lin-Kernighan heuristic or a 2-opt algorithm for the GTSP. Further, Non-Patent Literatures 5 and 6 each disclose a method for directly obtaining a quasi-optimum solution for the GTSP without conversion into the STSP. Next, an exemplary configuration of information processing according to the embodiments will be described.

### [Exemplary Configuration of Information Processing for Generating State Transition Order of Movable Member]

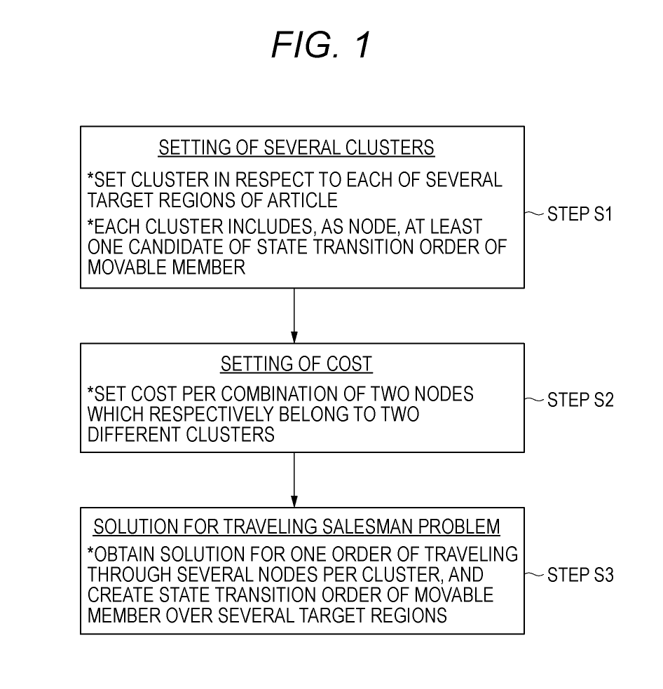

FIG. 1 is a chart (flowchart) showing a procedure of information processing for generating a state transition order of a movable member. The information processing may be carried out in an information processor of an article processing apparatus and the like having a movable member for article processing. The information processor generates the state transition order of the movable member. The information processor may include, for example, at least one of a logic circuit such as a CPU, a memory, a computer, and a workstation. The article processing herein may include, for example, measurement and/or processing for an article. For example, in case of measurement, the article processing may be measurement of an article such as a workpiece using a measurement head (or a measurement tool). In case of processing, the article processing may be processing of an article such as a workpiece using a processing head (or a processing tool). Further, the movable member may include a measurement head and/or a processing head such as the above-mentioned heads. Moreover, in cases where a holder (or a stage) which holds an article is movably configured in the measurement head or the processing head, the movable member may include the holder. In such article processing, several parts of a target article (called target parts or object parts) are provided in advance. Hereinafter, a case will be described, in which a measurement head or a processing head (or just a head or a tool) is used as a movable member, and in which the movable member moves relative to an article (or a workpiece) (a state transition of the movable member). It should be noted that the present invention is not restricted thereto. The present invention is also applicable for a case where a holder such as the above-mentioned one is used as a movable member and the movable member (article) moves relative to the head (the state transition of the movable member). Hereinafter, the procedure of the information processing for generating the state transition order of the movable member will be described with reference to FIG. 1.

In the article processing apparatus, several target parts are imparted to the article in advance. For example, in measuring a surface shape or processing a printed circuit board, a number of target parts densely exist, and a set of the target parts may be regarded as a region. Further, in measuring or processing a surface, there is a case where surface regions are set as target parts in the first place without densely setting the target parts. The set of such target parts or the target parts as regions will be called “target regions”. The article processing apparatus carries out article processing for several target regions by changing the state of the movable member. The article processing is generally carried out for the several target parts in series one by one. However, in a case of measurement, for example, there is a case where target parts are not discriminated from parts between the target parts, and those parts are measured continuously. Further, for example, there is a head capable of changing target parts at high speed in measurement or processing with light. Typical examples of the head include a processing head or a measurement head included in a galvano scanner. Further, for measurement, there are a head which simultaneously measures lined regions with a linear illumination and a line sensor, and a head which simultaneously measures surface regions with a surface lighting and a surface sensor. For contact type article processing for processing an article in contact with a head, there is a head which changes target parts at high speed by rotating the tip of the head at high speed.

Herein, the technology disclosed in Japanese Patent Application Laid-open No. 07-210586 is not practical when the number of the nodes becomes large, because calculation time required for solving a solution increases. By contrast, the technology recited in WO2003/064107 can reduce the number of the nodes per region in a TSP. However, in optimizing the state transition order of the movable member between the regions, the state transition order of the movable member within a predetermined region may not be guaranteed to be optimal. Therefore, the solution disclosed in WO2003/064107 is only a partial optimal solution. On the contrary, even if the transition order within the region is optimized after optimizing the transition order between several regions, the transition order between the predetermined regions may not be guaranteed to be optimal in optimizing the transition order within the region. Therefore, a solution to be obtained is only a partial optimal solution.

Accordingly, the present embodiment prepares several candidates regarding the state transition order of the movable member within the region. Further, the present embodiment determines the state transition order of the movable member within the region and between several regions by a solution for the TSP so that a sum of costs according to the transition order is minimized or quasi-minimized. As a result, an overall optimal solution for the transition order within the region and between the regions can be obtained. In this manner, the state transition order of the movable member which is advantageous in terms of time for article processing can be generated. Hereinafter, a procedure of information processing for generating the state transition order of the movable member will be described with reference to FIG. 1.

First, several clusters are set in Step S1. In an example of the setting, first, each target region is divided into sub-target regions in a predetermined shape. The sub-target regions in the predetermined shape herein represent regions in which the state transition order of the movable member (for example, a moving route) is previously determined. The regions may have several predetermined transition orders. An entrance and an exit are defined in each region. The predetermined shape may be at least one of a polygon, a circle, a sector, and a part of a cylindrical surface or a spherical surface. However, the predetermined shape is not restricted thereto and may be various shapes as long as the transition order can be defined. The transition order is not necessarily defined in advance for the shape. The transition order may be determined with application of an algorithm with which the target regions are divided and the transition order for each of the obtained sub-target regions is determined. In an example of such an algorithm, target regions are divided into several zonal regions (swath regions) and a transition order is generated by tracing (selecting) the obtained several zonal regions in a zigzag shape. Instead of the zigzag shape, the zonal regions may be in a serpentine shape, a square wave shape and the like. In such a case, there are several options for, for example, a direction of dividing the several zonal regions, and a setting of starting and terminal points in the transition order. Therefore, several candidates of the transition order can be set. Another example of the algorithm involves definition of a TSP as regarding, as a node, the state (such as a position and a posture) of the movable member for carrying out article processing for object parts within the sub-target region, and involves a solution for the TSP. In such a case, there are options for selecting nodes that are to be starting and terminal points of the obtained solution (obtained traveling route). Therefore, several candidates of the transition order can be set in each target region. The algorithm is not restricted to the one described above. Any algorithm can be used as long as several candidates of the transition order can be set within the target region.

Next, a cost (first cost) required for the movable member to transit from the starting point to the terminal point of the transition order is set in respect to each transition order candidate within each target region. Herein, the cost may be, for example, a value based on time required for the transition of the movable member (for example, the head and/or the stage). However, the cost is not restricted thereto. For example, the cost may be a value which directly or indirectly represents a certain cost such as an amount of change (amount of displacement) of the state of the movable member from the starting point to the terminal point, electric power (power consumption) required for the transition, an amount of heat generation in the transition, and time or energy required for the transition. It is preferable to set the cost by geometrically calculating the shortest route (the shortest route for transiting between the states) without interference or collision between the movable member and other materials so that the cost corresponds to the route. In case of setting a cost based on time required for transiting between the states, it is preferable to estimate the time required for the transition between the states based on specifications or characteristics of control according to the state transition of the movable member.

Hereinbefore, an example of setting the several candidates of the transition order in each target region has been described. However, the invention is not restricted thereto and one candidate of the transition order may be set in some target regions. This is because there is a case where, for example, only one candidate of the transition order can be set in respect to a certain target region because of, for example, a restriction of a driver according to the movable member and a restriction of article processing. Further, one candidate of the transition order may be set in respect to some target regions for the reason of reducing a frequency of calculation, time for calculation and the like. The more the number of candidates to be set increases, the more the calculation time required for solving the TSP increases. Therefore, the number of the candidates of the transition order in one target region is preferably less than the number of object parts within the target region. Moreover, the more the number of nodes increases, the more the time required for solving the TSP increases exponentially. Therefore, more preferably, the number of the candidates of the transition order in one target region should be ten percent or less of the number of the object parts within the target region.

In the above-mentioned way, the clusters are respectively set in respect to the several target regions of the article. Each cluster includes, as nodes, the several candidates of the state transition order of the movable member (as described above, some clusters may include one of the candidates as a node).

Subsequently, a cost is set in Step S2. In Step S2, first, regarding a combination of two nodes (candidates of the transition order) respectively belonging to two different clusters (target regions), a transition route from a terminal point of one node to a starting point of the other node is set. The route herein may be the geometrically shortest route. More preferably, the route may be the geometrically shortest route without interference or collision between the movable member and other materials. Note that the transition route is preferably set based on specifications or characteristics of control according to the state transition of the movable member. Next, a cost (second cost) according to the transition is set. The cost herein may be set by a method similar to the one which has set the cost (the above-mentioned first cost) in each target region. However, a method for setting the second cost is not restricted thereto. For example, in cases where a combination cost is determined as being apparently larger than other combination costs, or determined as exceeding a predetermined threshold, a sufficiently large value may be set without carrying out accurate or detailed computation (estimation). As a result, a load for setting the cost can be reduced. Further, in cases where a transition route of the movable member which is to be included in the transition order exists in advance, a sufficiently small value (for example, zero) may be set regardless of the actual cost in respect to a combination cost corresponding to the transition route. Next, a sum of the second cost which is set as described above and the above-mentioned first cost is obtained. Then, the sum is set as a cost according to the combination of the two nodes. Accordingly, the cost according to the transition in the target regions can be taken into consideration. Further, in detail, a cost for transiting from a target region A to a target region B is set by adding a cost (the first cost) according to the transition in the target region A to a cost (the second cost) according to the transition between those regions. The setting is carried out in respect to an arbitrary combination of two target regions. In such a way, the cost according to the transition in each target region can be taken into consideration. Hereinbefore, an example of adding the first cost, which is in the target region A, to the second cost, which is from the target region A to the target region B, has been exemplified, but the invention is not restricted thereto. That is, a method of adding the first cost, which is in the target region B, to the second cost, which is from the target region A to the target region B, may be applied as well. In short, as long as a similar method is applied to all the combinations of the target regions, either method may be adopted. In the above-mentioned way, the cost is set to each of several combinations of two nodes (candidates of the transition order) respectively belonging to two different clusters (target regions).

Subsequently, the TSP is solved in Step S3. First, the A-GTSP is defined with the several clusters and the several costs which have been set in Steps S1 and S2. Herein, the A-GTSP may be one defined in the above-mentioned Non-Patent Literature 4 but is not restricted thereto. In such a case, each candidate of the transition order in each target region corresponds to a node in an A-GTSP graph. Further, each cluster set in Step S1 corresponds to a cluster in the A-GTSP graph. Still further, each cost set in Step S2 (the sum of the first and second costs) corresponds to a cost in the A-GTSP graph. Note that the definition of the A-GTSP more specifically implies creating data which fits to a data format of a solver (solution software) of the A-GTSP based on information of the above-mentioned node, cluster and cost. As described above, in case of obtaining the solution by converting the A-GTSP into an STSP, it is sufficient to create data in a data format of the STSP or to convert A-GTSP data into STSP data. Various methods for converting an A-GTSP into an STSP are known in the related art, and the method is not restricted to the above-mentioned method. Further, the node is not restricted to each candidate of the transition order in each target region. For example, the node may include an initial state of the movable member, and the state or the transition order of the movable member predetermined for alignment and calibration (such as an origin calibration) for the movable member and the like.

Subsequently, the above-defined TSP is solved. As described above, an exact solution for the A-GTSP can be obtained, for example, by employing the solver (the software tool) which converts an A-GTSP into an STSP and employs a solution such as an exact solution for the STSP recited in Non-Patent Literature 2. It should be noted that obtaining the exact solution requires a large load on computation. Therefore, a solution for obtaining a quasi-optimum solution having less computation load than the exact solution can be employed. The quasi-optimum solution for the STSP obtained by converting the A-GTSP may not be guaranteed as a feasible solution for the original A-GTSP. Therefore, the quasi-optimum solution may be obtained by employing a solution which obtains the quasi-optimum solution for the GTSP recited in Non-Patent Literature 6. The solution for the A-GTSP is not restricted to the solutions recited in Non-Patent Literatures 1 to 6, and the known solutions other than those solutions may be utilized. The solution for the A-GTSP obtained in the above-mentioned way corresponds to a route (the state transition order of the movable member) which visits one node per cluster and makes a circuit of all the clusters at a minimum or quasi-minimum cost. In other words, according to the solution, a transition route between the target regions is determined and at the same time candidates for the transition order in each target region are selected. Then, the route (the state transition order of the movable member) which makes a circuit of all the target parts at a minimum or quasi-minimum cost is generated. That is, the obtained solution is an overall optimal solution considering both the cost according to each target region and the cost between the target regions in parallel (in series or at the same time but not separately). As a result, the state transition order of the movable member which is advantageous in terms of time for article processing can be obtained.

Subsequently, in Step S3, the obtained solution (the state transition order of the movable member) is output. Herein, a destination of the output may be at least one of a controller (hereinafter described), a storage unit, a computation unit other than these units, and a storage medium of an article processing apparatus. Although the route obtained by the solution for the TSP is a traveling route, the route does not need to make a circuit (return to the first node or the first state) depending on specifications or usage of the article processing apparatus. In such a case, a route (transition order) from a starting point (a first state or a first node) to a terminal point (a last state or a last node) may be output. Herein, the starting and terminal points may be determined, for example, as follows. First, one node among a combination of adjacent nodes, which have the largest second cost in the route (transition order) obtained as a solution, may be set as the starting point, and the other node may be set as the terminal point. As a result, an effect advantageous in terms of time for article processing can be expected. Alternatively, a node, which is closest to the initial state of the movable member in the route (transition order) obtained as a solution, may be set as the starting point. On the other hand, a node which has a larger second cost required for transiting from the starting point, among two nodes adjacent to the starting point, may be set as the terminal point. A method for setting the starting and terminal points is not restricted thereto, and various methods can be adopted as required.

According to the above-mentioned method for information processing, technology of generating a state transition order of a movable member which is advantageous in terms of time for article processing can be provided.

[Exemplary Configuration of Article Processing Apparatus which Carries Out Information Processing]

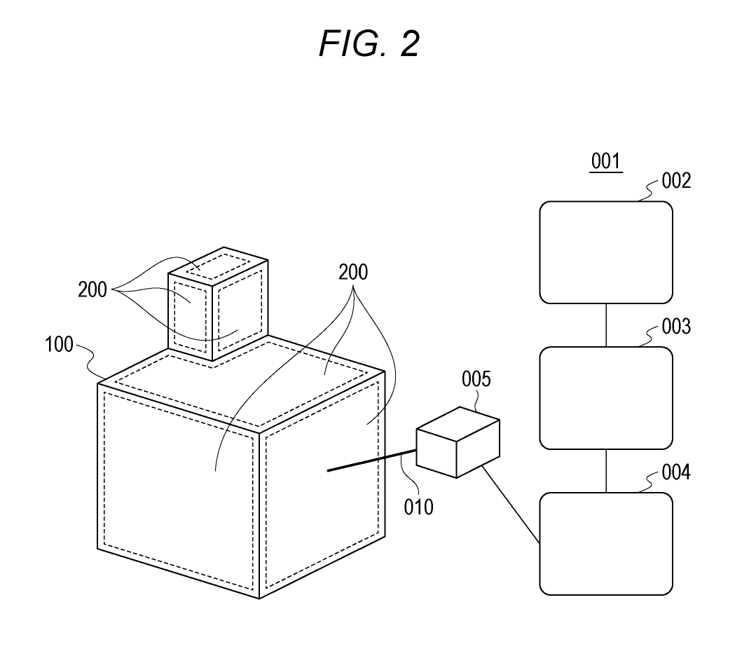

Hereinafter, an exemplary configuration of an article processing apparatus which carries out the above-mentioned information processing method will be described. FIG. 2 is a view showing a measuring device as an exemplary configuration of the article processing apparatus. Herein, the measuring device will be described as an example, but it is obvious for those skilled in the art that the above-mentioned information processing method is also applicable for a processing device and other article processing apparatuses. The measuring device herein will be described as a non-contact type measuring device. The non-contact type measuring device irradiates a workpiece as an article with light from a measurement head, and measures characteristics (such as a shape) of the workpiece. However, the measuring device is not restricted thereto. For example, the measuring device may be a contact type measuring device which brings a measurement head (probe) into contact with a workpiece, and measures characteristics of the workpiece. Similarly, in case of a processing device, the device may be a contact type processing device in which a processing head is brought into contact with a workpiece. Alternatively, the device may be a non-contact type processing device in which a processing head is not brought into contact with a workpiece as in laser processing.

In FIG. 2, an article processing apparatus (measuring device) 001 includes a controller 003, an information processor 002, a driver 004, and a movable member 005. The movable member 005 irradiates an article (workpiece) 100 with measurement light 010. The measurement light 010 is reflected or scattered by the workpiece 100 and the reflected light or the scattered light is received by the movable member 005. The controller 003 measures position coordinates of target parts in the workpiece 100 or a distance between the target parts and the movable member 005 based on information of the received light. The target parts may be set in advance by a user or automatically set by the controller 003. A number of the target parts are densely set on the workpiece 100, but are not shown in the drawings. Instead of showing the target parts, a region 200 encircled by dotted lines is shown as a set of the target parts.

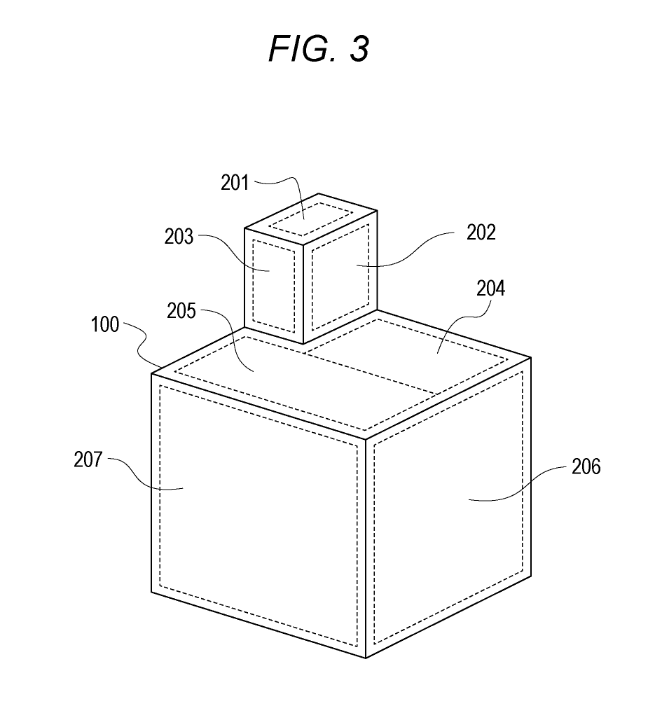

Details of information processing carried out by the information processor 002 will be described with reference to FIGS. 3 to 9C. Prior to the information processing, the controller 003 inputs information into the information processor 002 as required. The information herein is about, for example, a shape of an article, target parts or target regions, specifications (elements) of the article processing apparatus 001, and required measurement accuracy. Herein, the information about the shape of the article may be a designed value of the shape of the article or information of the shape of the article simply measured in advance. The information about the specifications of the article processing apparatus 001 may include information about a restriction required for the article processing (measurement herein). The restriction herein may be, for example, a drivable range of the driver 004, an upper limit of speed and acceleration of the movable member 005 obtained by the driver 004, positioning accuracy of the movable member 005, and measurement accuracy.

First, FIG. 3 schematically shows a result in which the information processor 002 divides the region 200 into target regions in a predetermined shape, as an action according to the above-mentioned Step S1. In FIG. 3, the region 200 is divided into rectangular target regions 201 to 207. Herein, FIG. 3 is an example in which the region 200 is divided in series, along the outline of the region 200, into the rectangular target regions which are sufficient to cover the region 200. However, the division is not restricted thereto and may be those based on various algorithms. For example, in cases where the region 200 includes a curved surface, the division may be based on an algorithm with which the region 200 is divided into rectangular target regions in which an amount of deviation from the curved surface is within an allowable range. The shape of the target regions is not restricted to a rectangle, and may be other polygons. Alternatively, the shape of the target regions may be one having the smallest amount of deviation from the region 200 by fitting the region 200 to various shapes such as a part of a cylindrical surface and a part of a spherical surface. Further, in cases where the above-mentioned information about the shape of the article includes information about the shape of the target regions, the shape of the target regions may be one based on the information about the shape of the target regions.

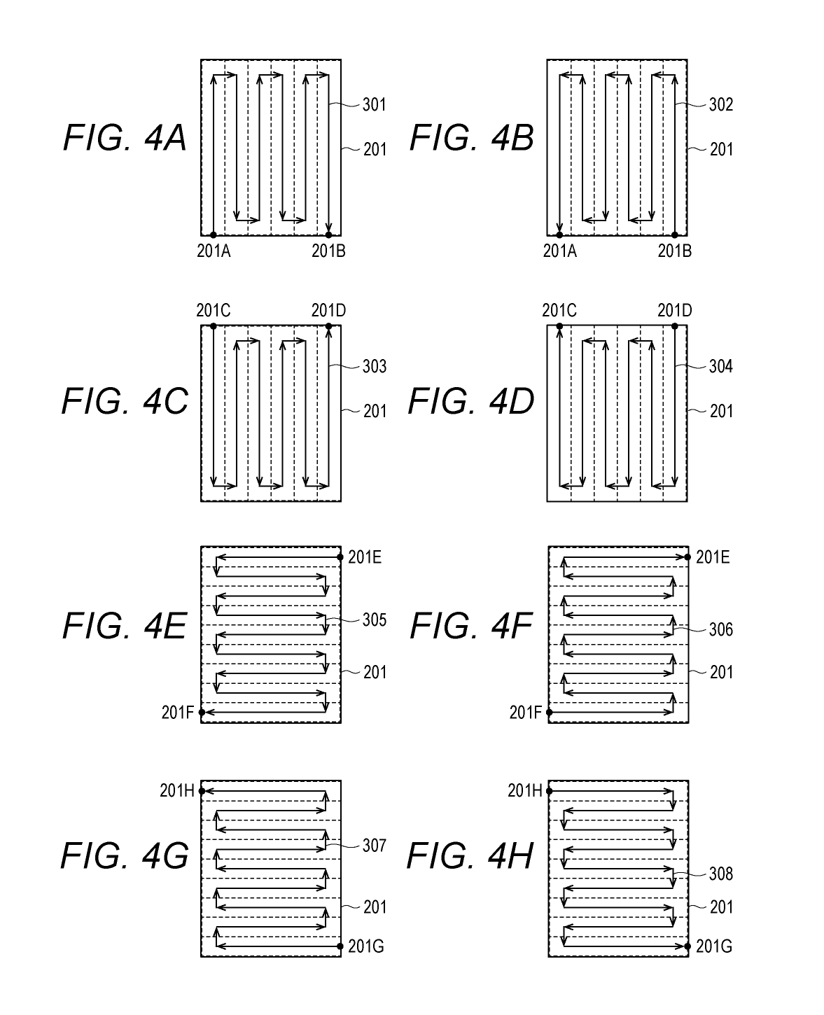

Herein, the movable member 005 (measurement head) may include, for example, a galvanomirror in order to change a direction of the measurement light 010 at high speed. In such a case, the movable member can scan the target regions with light at high speed at least in one direction. The movable member 005 further includes a line sensor or an area sensor so as to detect light in parallel regarding a linear region or an area region. Such a movable member 005 (measurement head) can detect light at high speed at least in one direction (high-speed detectable direction). Therefore, a direction in which the driver 004 displaces (changes a state of) the movable member 005 is preferably vertical to or other than the high-speed detectable direction. Accordingly, it is preferable to divide the target region 201 into zonal regions having a short-side direction in the high-speed detectable direction in which light is detectable at high speed, while meeting the requirement of desired measurement accuracy. Then, a direction along a longitudinal direction of each zonal region is preferably set as a direction of displacement of the movable member 005 relative to the target region 201. FIG. 4A shows a case where the longitudinal direction of each zonal region is brought into line with the long side of the target region 201. The dotted lines represent zonal regions. A candidate 301 of a state transition order of the movable member is also shown. The candidate 301 of the transition order includes a starting point 201A and a terminal point 201B. Similarly, FIGS. 4B to 4D show the cases where the longitudinal direction of each zonal region is brought into line with the long side of the target region 201. Herein, FIGS. 4B to 4D respectively show different candidates 302 to 304 of the transition order. FIGS. 4A to 4D have different starting points and terminal points of the candidates of the transition order. FIGS. 4E to 4H show the cases where the longitudinal direction of each zonal region is brought into line with the short side of the target region 201. Herein, FIGS. 4E to 4H show candidates 305 to 308 of the transition order. FIGS. 4E to 4H have different starting points and terminal points of the candidates of the transition order. In such a way, several candidates of the transition order can be set in one target region by changing an orientation of the longitudinal direction of the zonal region or changing the starting point and the terminal point of the candidates of the transition order as described above. Note that, the more the number of the zonal regions increases, the more the frequency of acceleration and deceleration of the movable member increases. Therefore, the increase in the number of the zonal regions may be disadvantageous in terms of shortening measurement time. For example, regarding the target region 201, a case where the longitudinal direction of each zonal region is brought into line with the long side of the target region 201 has a less number of the zonal regions than other cases. Accordingly, the candidates 301 to 304 of the transition order may be advantageous in terms of measurement time than the candidates 305 to 308 of the transition order. However, those are partially optimal transition orders. That is, those transition orders may not be guaranteed as a part of an overall optimal transition order including a transition between the target regions, in a case where positions of the starting and terminal points of the transition order according to the target region should be taken into consideration. Accordingly, in setting the candidates of the transition order according to the target region, it is necessary to consider not only costs according to the target region but also costs according to the transition between the target regions (between the target region 201 and other target regions). Further, several candidates can be set in the transition order by changing the starting point and the terminal point as can be seen in the candidates 301 to 304 of the transition order. Setting such several candidates can be regarded as being useful, considering the costs according to the transition between the target regions. In such a way, appropriately setting each of the several candidates of the transition order according to the target region 201 is preferable in obtaining an overall optimal solution based on the transition order between the target regions.

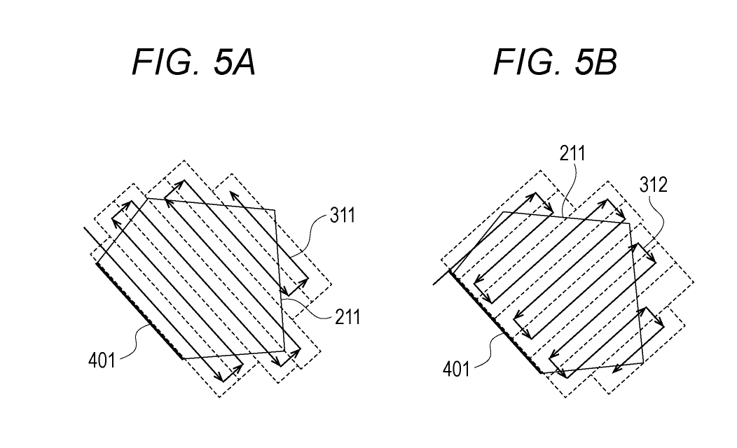

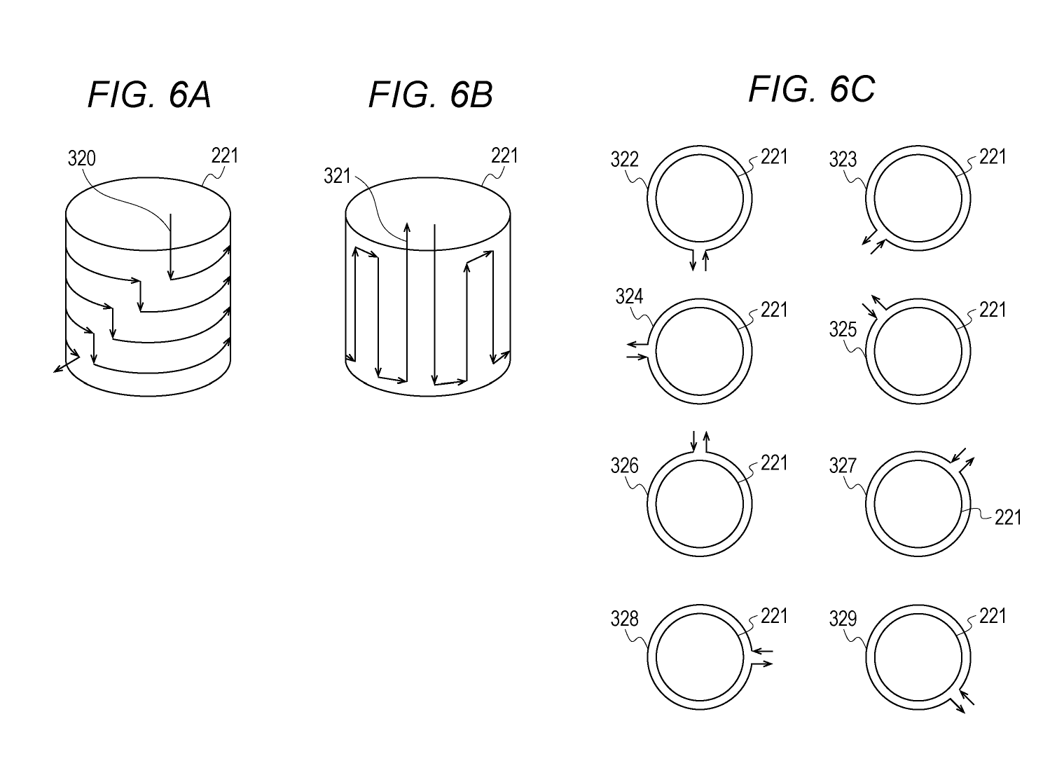

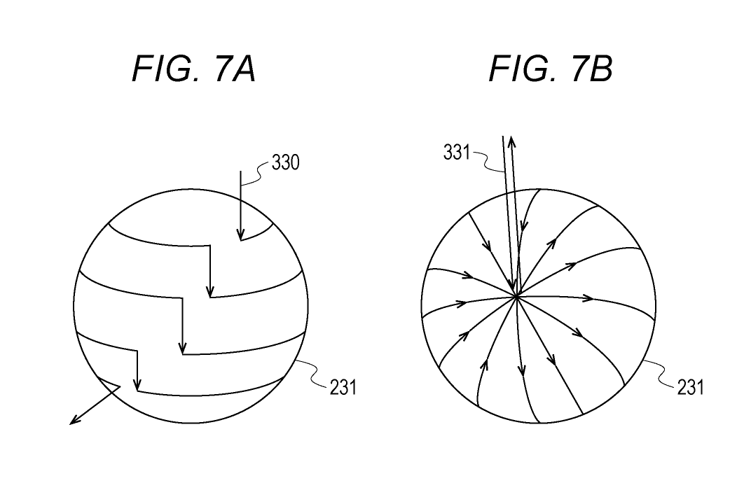

Hereinbefore, the example of the target regions in a rectangular shape has been described, but the target regions may be in the shape of a polygon other than a rectangle. Such cases are shown in FIGS. 5A and 5B. FIGS. 5A and 5B are examples in which pentagonal target regions 211 are divided into zonal regions which are shown with dotted lines, where both candidates 311 and 312 of transition orders are set. The candidate 311 of the transition order can be obtained by arranging the zonal regions having the longitudinal direction parallel to a side 401 included in an outline of a polygon (a pentagon herein). On the other hand, the candidate 312 of the transition order can be obtained by arranging the zonal regions having the longitudinal direction vertical to the side 401. As described above, even in a case where the target region is in the shape of a polygon other than a rectangle, several candidates of the transition order can be set by arranging the longitudinal direction of the zonal region parallel and vertical to one side included in the outline of the polygon. FIGS. 6A to 6C show examples in which several candidates of a transition order are set in a target region included in a cylindrical surface. In a target region 221 included in the cylindrical surface, for example, candidates 320 and 321 of the transition order can be set as shown in FIGS. 6A and 6B. Other candidates of the transition order regarding the target region 221 can be set without being restricted to the candidates 320 and 321 of the transition order. FIG. 6C is a diagram showing various combinations of starting and terminal points of the candidates of the transition order regarding the target region 221 included in the cylindrical surface. FIG. 6C is a plan view of a cylinder according to FIG. 6B (as viewed from a direction where the cylinder can be seen as a circle). FIG. 6C shows several candidates 322 to 329 which are similar to the candidate 321 of the transition order (same in shape), and which have different positions of the starting and terminal points on circumferences. Several candidates of the transition order can also be set depending on a way of selecting the starting and terminal points. In such a case, from a practical point of view, it is preferable to operate the information processor 002 in accordance with an algorithm with which several candidates having different positions of starting and terminal points are set on a circumference in a preset angle interval or angle range. Similarly, FIGS. 7A and 7B are diagrams exemplifying several candidates of a transition order according to a target region 231 on a spherical surface. Candidates 330 and 331 of the transition order are shown in FIGS. 7A and 7B, respectively. Herein, the candidate 330 of the transition order is generated by repeating a transition in which a polar point set in the target region 231 on the spherical surface makes a circuit along a parallel of latitude (latitude line) and then changes latitude. On the other hand, the candidate 331 of the transition order is generated by repeating a transition in which a polar point set in the target region 231 on the spherical surface makes a circuit along a meridian and then changes longitude. Even for the candidates shown in FIGS. 7A and 7B, several candidates can be set by changing the longitude of a starting point in FIG. 7A and the longitude of an initial meridian in FIG. 7B.

Subsequently, costs required for a transition are set as described above in respect to each of the several candidates of the preset transition order. Hereinbefore, the examples have been described, in which the several candidates of the transition order are set when the target regions are in the shape of a rectangle, other polygons (e.g. pentagon), a cylindrical surface and a spherical surface. However, the target region is not restricted thereto and may be in an arbitrary shape in which several candidates of the transition order can be set. Further, the example in which the transition order is generated by traveling through the several zonal regions in a zigzag shape has been described. However, an aspect of generating the several candidates of the transition order is not restricted thereto. For example, the several candidates of the transition order may be generated by an aspect in which a traveling route (transition order) according to each target region can be obtained by solving a TSP in which each of several target parts (not shown) is regarded as a node. In such a case, several candidates of the transition order can be set by specifying different starting and terminal points in the obtained traveling route. Herein, in aiming at reducing calculation time, a candidate having a sufficiently large cost compared to other candidates can be excluded in accordance with a predetermined condition. Further, a candidate which is difficult to adopt because of a restriction of specifications (elements) of the article processing apparatus 001 can be excluded as well.

In the above-mentioned way, the information processor 002 carries out processing according to the above-mentioned Step S1 (setting of several clusters). In selecting a transition order from several candidates of the transition order set per target region in such a way, costs required for transiting between the target regions should be taken into consideration as described above. However, a huge number of candidates may exist in a route for transiting between the target regions. Accordingly, a combination of candidates, among combinations of a further huge number of candidates, in which the costs are minimized or quasi-minimized should be obtained. Note that the combinations of a further huge number of candidates are obtained by selecting, in series, the candidates of the transition order according to the target region in respect to each of the huge number of candidates for transiting between the target regions. However, it is difficult to obtain an optimal solution by obtaining all costs of the combinations of such a huge number of the candidates. Therefore, in the present embodiment, this problem is defined (formulated) as an A-GTSP, and an optimal solution or a quasi-optimum solution in which costs are minimized or quasi-minimized will be obtained by solving the A-GTSP. Hereinafter, processing according to the definition of the A-GTSP of the information processor 002 will be described.

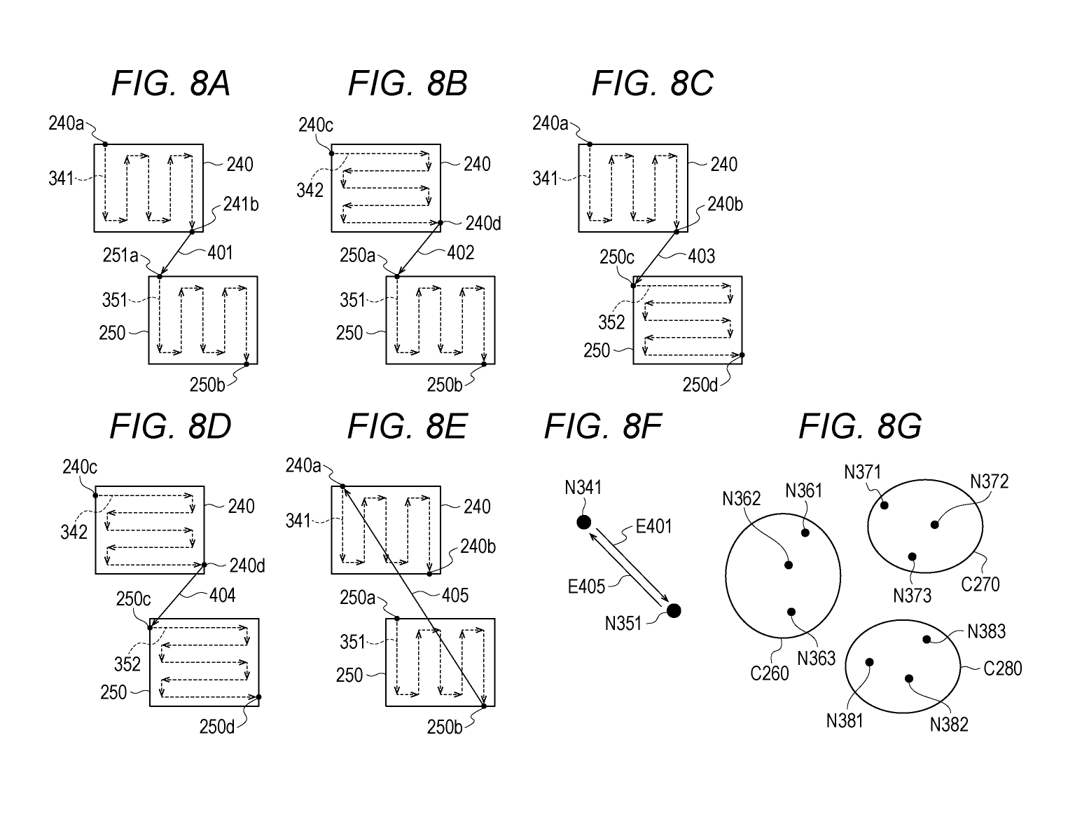

Subsequently, the information processor 002 carries out processing according to the above-mentioned Step S2 (setting of cost). That is, costs are set per combination of two nodes which respectively belong to two different clusters. Setting of the costs will be described with reference to FIGS. 8A to 8G. FIGS. 8A to 8G schematically show transition order candidates 341 and 342 according to a target region 240 and transition order candidates 351 and 352 according to a target region 250. The candidate 341 includes a starting point 240a and a terminal point 240b. The candidate 342 includes a starting point 240c and a terminal point 240d. The candidate 351 includes a starting point 251a and a terminal point 250b. The candidate 352 includes a starting point 250c and a terminal point 250d. The combination of the two nodes which respectively belong to the two different clusters is represented by, for example, a combination of the candidate 341 according to the target region 240 and the candidate 351 according to the target region 250. A transition route 401 according to the above-mentioned combination is schematically shown in FIG. 8A. Similarly, a transition route 402 according to a combination of the candidates 342 and 351 is schematically shown in FIG. 8B. Further, a transition route 403 according to a combination of the candidates 341 and 352 is schematically shown in FIG. 8C. Still further, a transition route 404 according to a combination of the candidates 342 and 352 is schematically shown in FIG. 8D. Costs of a transition according to such combinations (the route 401 etc.) of nodes are set based on a sum of the first and second costs as described above (see Step S2). The costs of the transition according to the combinations of the nodes have asymmetry as well as different values between a forward direction and a backward direction. For example, while the transition route from the candidate 341 to the candidate 351 is 401 (see FIG. 8A), the transition route from the candidate 351 to the candidate 341 is not 401 but 405 (see FIG. 8E).

Hereinafter, an asymmetric graph of the A-GTSP according to the present embodiment will be described. First, FIG. 8F is a diagram which schematically shows nodes, edges and costs used in a TSP. Herein, a node N341 corresponds to the transition order candidate 341 according to the target region 240, while a node N351 corresponds to the transition order candidate 351 according to the target region 250. An edge E401 corresponds to the transition route 401 between the two nodes, while an edge E405 corresponds to the transition route 405 between the two nodes. A property in which edges and costs between two nodes mutually differ depending on the direction (forward direction and backward direction) is called asymmetry or directivity. A graph drawn with nodes and asymmetric edges (or costs) is called an asymmetric graph. In this way, an asymmetric graph can be plotted by setting, as a node, each of several candidates of a transition order according to each target region, and setting, as an edge, a transition route between target regions. FIG. 8G is a diagram exemplifying an asymmetric graph. Herein, three clusters C260, C270 and C280 respectively correspond to target regions 260, 270 and 280. The cluster C260 includes three nodes N361 to N363 which respectively correspond to three transition order candidates 361 to 363. Similarly, the cluster C270 includes three nodes N371 to N373 which respectively correspond to three transition order candidates 371 to 373. Similarly, the cluster C280 includes three nodes N381 to N383 which respectively correspond to three transition order candidates 381 to 383. Although edges are not shown in the graph for fear that the graph should be complicated, the edges connect two nodes to each other which respectively belong to two different clusters. Costs of each edge are asymmetrically set as described above. The (A-)GTSP herein is a problem for obtaining a traveling route which visits one node per cluster and makes a circuit of all the clusters, and in which a sum of costs is minimized or quasi-minimized. Accordingly, when the A-GTSP according to the above-mentioned asymmetric graph is solved, the traveling route in which the sum of the costs is minimized or quasi-minimized can be obtained as well. The traveling route selects one candidate from the several transition order candidates according to each target region and makes a circuit of all the target regions. The example using the asymmetric graph according to FIG. 8G has been described, but the invention is not restricted thereto. That is, as described above, an A-GTSP is convertible into an ATSP, an STSP and the like. Accordingly, a graph according to an ATSP or an STSP equivalent to the above-mentioned A-GTSP (or an ATSP or an STSP obtained by being converted from the A-GTSP) may also be employed. A solution for the problem according to the graph can be obtained by means of a solution for the ATSP or the STSP.

Subsequently, the information processor 002 carries out processing according to the above-mentioned Step S3 (solution for TSP). The information processor 002 creates data in accordance with a data format of a solver (solution software) of the A-GTSP based on installed information of the preset clusters (including the nodes) and the costs (according to the edges).

Further, in case of solving the ATSP or the STSP converted from the A-GTSP (or the ATSP or the STSP equivalent to the A-GTSP), data according to the A-GTSP may be converted into data according to the ATSP or the STSP. Alternatively, the data according to the ATSP or the STSP may be directly created without involving the A-GTSP. Based on the data, the information processor 002 obtains a solution for the traveling route (the state transition order of the movable member) in which total costs (a sum of the first and second costs) are minimized or quasi-minimized by using the solver for the TSP such as the A-GTSP.

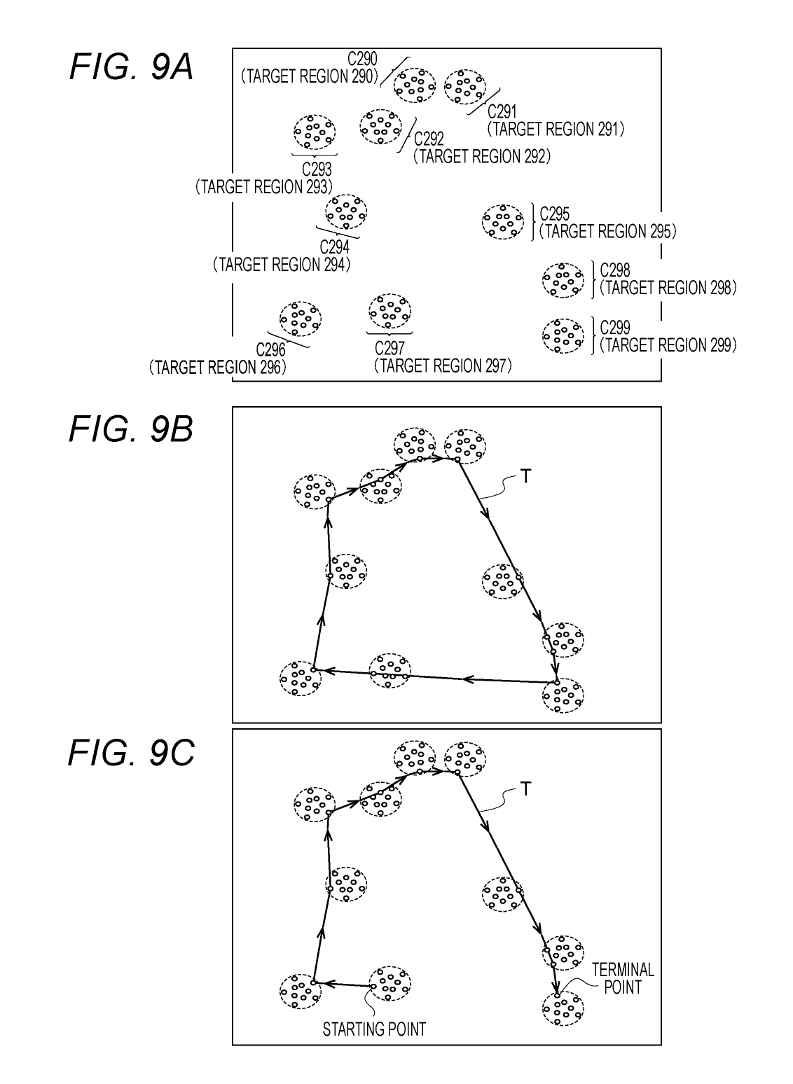

FIGS. 9A to 9C are an asymmetric graph and diagrams exemplifying traveling routes (state transition orders of the movable member) obtained by the information processor 002. FIG. 9A is an asymmetric graph according to target regions 290 to 299. In each target region (each cluster), several transition order candidates are set as nodes (shown with circles of solid lines). Each cluster is shown with a circle of a dotted line. Asymmetric edges (and costs corresponding to the edges) are set but not shown for fear that the graph should be complicated. FIG. 9B is a diagram showing a traveling route (transition order) T as a result of solving the A-GTSP according to the asymmetric graph with the solver. In the traveling route T, costs in the graph are minimized or quasi-minimized. In such a way, according to the present embodiment, the state transition order of the movable member 005, in which costs are minimized or quasi-minimized, can be obtained. The information processor 002 outputs the obtained transition order T to the controller 003.

Herein, the example in which the information processor 002 is provided inside the article processing apparatus 001 has been described, but the invention is not restricted thereto. For example, by setting an external device corresponding to the information processor 002, information of the transition order T may be input from the external information processing device 002 to the article processing apparatus 001 through a storage medium or a communication medium. The transition order T is a traveling route in the above-mentioned example, but may be a route including a starting point and a terminal point of a state as shown in FIG. 9C when the movable member 005 does not need to make a circuit. FIG. 9C is a diagram in which the traveling route T in FIG. 9B has been changed.

Due to such a change, the node within the target region 297 (cluster C297) is set as a starting point (a transition order according to a first target region), while the node within the target region 299 (cluster C299) is set as a terminal point (a transition order according to a last target region). Herein, the starting point and the terminal point may be determined by means of the above-mentioned various methods.

According to the above-mentioned configuration, an article processing apparatus which generates a state transition order of a movable member which is advantageous in terms of time for article processing can be provided.

### [Specific Example of Measuring Device]

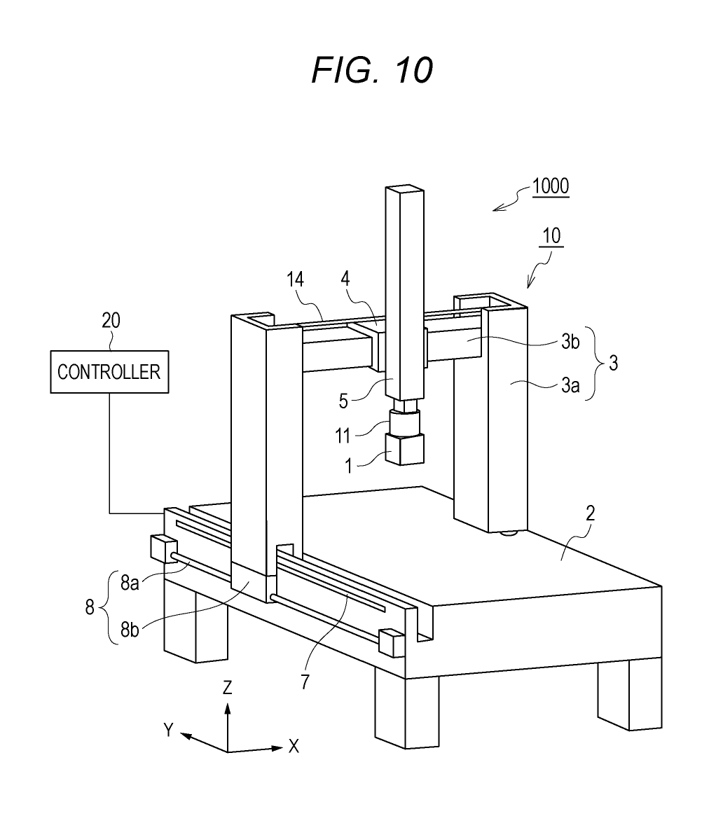

Herein, a measuring device 1000 as a specific example of the article processing apparatus 001 except for the information processor 002 in FIG. 2 will be described in further detail with reference to FIG. 10. FIG. 10 is a view showing a specific example of the measuring device 1000. The measuring device 1000 includes a measurement head 1, a driver 10, and a controller 20. The measurement head 1 (corresponding to the movable member 005 in FIG. 2) measures a shape of a test object. The driver 10 (corresponding to the driver 004 in FIG. 2) drives the measurement head 1. The controller 20 (corresponding to the controller 003 in FIG. 2) controls the measurement head 1 and the driver 10. The measuring device 1000 measures the shape of the test object, for example, by making the measurement head 1 transition along a surface of the test object (test surface) so that the distance between the measurement head 1 and the test surface falls within a tolerance level. The transition herein may be called a movement or a motion, and may include a change not only in a position but also in a posture. As a measurement method of the measurement head 1, various methods may be adopted. For example, an optical cutting method (linear light projection triangulation), a time of flight (TOF) method, an optical interferometry, and a probe contact method may be adopted as well. However, the measurement method is not restricted thereto.

Hereinafter, an exemplary configuration of the driver 10 will be described. The driver 10 includes, for example, a surface plate 2 on which the test object is disposed, a Y carriage 3, an X slider 4, a Z spindle 5, and a rotary head 11. The Y carriage 3 is configured in a gate-shape with a pair of legs 3a and an X beam 3b, and is supported by the surface plate 2 through an air guide. One leg 3a of the Y carriage 3 includes a Y driver 8 which drives the Y carriage 3 in a Y direction. The Y driver 8 includes a Y shaft 8a provided to the surface plate 2 and a Y movable member 8b provided to the Y carriage 3. The Y carriage 3 can be driven in the Y direction as the Y movable member 8b moves along the Y shaft 8a. The X slider 4 is supported by the X beam 3b of the Y carriage 3 through an air guide, and includes an X driver which drives the X slider 4 in an X direction. The X driver includes an X shaft 14 provided to the Y carriage 3 and an X movable member provided to the X slider 4. The X slider 4 can be driven in the X direction as the X movable member moves along the X shaft 14. The Z spindle 5 is supported by the X slider 4 through an air guide and includes a Z driver which drives the Z spindle 5 in a Z direction. The Z driver includes a Z shaft provided to the X slider 4 and a Z movable member provided to the Z spindle 5. The Z spindle 5 can be driven in the Z direction as the Z movable member moves along the Z shaft. The leading end of the Z spindle 5 includes the measurement head 1 with the rotary head 11 interposed therebetween. The rotary head 11 can rotate the measurement head 1 around an X-axis, a Y-axis, and a Z-axis. This enables the measurement head 1 to change its posture.

With the above-mentioned configuration of the driver 10, the measuring device 1000 can measure the shape of the test object while changing the position and posture of the measurement head 1. The driver 10 herein includes, for example, a Y encoder 7, an X encoder, and a Z encoder. The Y encoder is for measuring a position of the Y carriage 3 in the Y direction. The X encoder is for measuring a position of the X slider 4 in the X direction. The Z encoder is for measuring a position of the Z spindle 5 in the Z direction. The measuring device 1000 can obtain a position coordinate of the measurement head 1 based on the position of the Y carriage 3 measured with the Y encoder 7, the position of the X slider 4 measured with the X encoder, and the position of the Z spindle 5 measured with the Z encoder. Similarly, the measuring device 1000 can obtain the posture of the measurement head 1, that is, a rotation angle around each axis of the rotary head 11 with a measuring instrument such as a rotary encoder. Hereinbefore, the configuration of the measuring device 1000 as an article processing apparatus has been described. However, it should be noted that the configuration of the article processing apparatus is merely a specific example and is not restricted thereto. For example, the article processing apparatus may be configured as various processing devices such as a laser processing device, various inspection devices such as a non-destructive testing device, and various lithography devices such as a semiconductor exposure device.

### Other Embodiments

Embodiments of the present invention can also be realized by a computer of a system or apparatus that reads out and executes computer executable instructions recorded on a storage medium (e.g., non-transitory computer-readable storage medium) to perform the functions of one or more of the above-described embodiment(s) of the present invention, and by a method performed by the computer of the system or apparatus by, for example, reading out and executing the computer executable instructions from the storage medium to perform the functions of one or more of the above-described embodiment(s). The computer may comprise one or more of a central processing unit (CPU), micro processing unit (MPU), or other circuitry, and may include a network of separate computers or separate computer processors. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

Hereinbefore, the embodiments of the present invention have been described. However, it should be noted that the present invention is not restricted thereto and can be modified or changed within the scope of the gist of the present invention.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2013-136920, filed Jun. 28, 2013, which is hereby incorporated by reference herein in its entirety.

What is claimed is:

1. An article processing apparatus having a movable member for article processing, the apparatus comprising:
an information processor configured to:
set a plurality of clusters each of which includes, as a plurality of nodes, a plurality of candidates of a transition order of states of the movable member with respect to each of a plurality of target regions of an article,
set a plurality of costs respectively to a plurality of combinations of two nodes which respectively belong to two mutually different clusters of the plurality of clusters, and
generate a transition order of states of the movable member over the plurality of target regions by obtaining, as a solution of a traveling salesman problem, an order of traveling through a plurality of nodes each selected from each of the plurality of clusters, based on the plurality of clusters and the plurality of costs.

2. The article processing apparatus according to claim 1, wherein the apparatus is configured to set a cluster which includes, as a node, only one candidate of a transition order of states of the movable member with respect to a target region of the article.

3. The article processing apparatus according to claim 1, wherein the apparatus is configured to perform, as the article processing, at least one of measurement and manufacture for the article.

4. A generating method of generating a transition order of states of a movable member for article processing, the method comprising steps of:
setting a plurality of clusters each of which includes, as a plurality of nodes, a plurality of candidates of a transition order of states of the movable member with respect to each of a plurality of target regions of an article;
setting a plurality of costs respectively to a plurality of combinations of two nodes which respectively belong to two mutually different clusters of the plurality of clusters; and
generating a transition order of states of the movable member over the plurality of target regions by obtaining, as a solution of a traveling salesman problem, an order of traveling through the plurality of nodes each selected from each of the plurality of clusters, based on the plurality of clusters and the plurality of costs.

5. The method according to claim 4, further comprising a step of setting a cluster which includes, as a node, only one candidate of a transition order of states of the movable member with respect to a target region of the article.

6. The method according to claim 4, wherein the step of setting the plurality of clusters sets each of the plurality of clusters not to include a node related to a state, of states of the movable member, in which the movable member interferes with an object.

7. The method according to claim 4, wherein each of the plurality of costs includes a first cost related to transition of states in one node of the two nodes, and a second cost related to transition of states between the two nodes.

8. The method according to claim 4, wherein the step of setting the plurality of costs sets each of the plurality of costs based on at least one of time required for transition of states of the movable member and an amount of change in transition of states of the movable member.

9. The method according to claim 4, further comprising steps of:
dividing one of the plurality of target regions into a plurality of sub-target regions; and
generating the plurality of candidates based on the plurality of sub-target regions with respect to the one of the plurality of target regions.

10. The method according to claim 9, wherein each of the plurality of candidates is generated by selecting the plurality of sub-target regions in series in a serpentine curve or a square wave.

11. The method according to claim 4, wherein, as the solution, a solution of an asymmetric generalized traveling salesman problem is obtained.

12. The method according to claim 4, wherein, as the solution, a solution of a symmetric traveling salesman problem or an asymmetric traveling salesman problem, obtained by converting an asymmetric generalized traveling salesman problem, is obtained.

13. The method according to claim 12, wherein the solution of the symmetric traveling salesman problem or the asymmetric traveling salesman problem is obtained with a solving method by which an exact solution is guaranteed.

14. The method according to claim 12, wherein the solution of the symmetric traveling salesman problem or the asymmetric traveling salesman problem is obtained with a solving method by which a quasi-optimum solution is given.

15. The method according to claim 11, wherein the solution of the asymmetric generalized traveling salesman problem is obtained with a solving method by which a quasi-optimum solution is given.

16. The method according to claim 7, wherein the transition order is generated by setting, as a first state of the transition order, one node of a combination, of which the second cost is greatest, of the combinations in the solution, and by setting, as a last state of the transition order, the other node of the combination.

17. The method according to claim 4, wherein a first state of the transition order is determined based on information of an initial state of the movable member.

18. The method according to claim 17, wherein a last state of the transition order is determined as a state corresponding to a node, of two nodes adjacent to a node related to the first state, to which the second cost is required more for transition from the node related to the first state.

19. The method according to claim 4, wherein the article processing includes at least one of measurement and manufacture for the article.

20. A computer-readable storage medium which stores a program for causing a computer to execute a generating method, defined in claim 4, of generating a transition order of states of a movable member for article processing.
